(19) United States
(12) Patent Application Publication
(10) Pub. No.: US 2006/0253396 A1
(43) Pub. Date: Nov. 9, 2006

(54) Information processing device, system thereof, method thereof, program thereof and recording medium recording the program

(75) Inventor: Tsutomu Ohkawa, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: PIONEER CORPORATION, Tokyo (JP); INCREMENT P CORPORATION, Tokyo (JP)

(21) Appl. No.: 11/401,479

(22) Filed: Apr. 11, 2006

(30) Foreign Application Priority Data
Apr. 12, 2005 (JP) 2005-114808

(51) Int. Cl. G06Q 99/00; H04L 9/00; H04K 1/00

(52) U.S. Cl. 705/50; 705/64

(57) ABSTRACT

A public key generated in a shop terminal (300) by making a pair with a private key is transmitted to a server (200) with a created web file and stored in the server. When request information for requesting performance of commerce and commerce details information are set and input in the terminal (400) according to the web file, the shop terminal (300) recognizes that the server (200) has made an order request, and requests a download processing of the commerce details information. The server (200) encrypts the commerce details information into first encryption information with a common key, encrypts the first encryption information and the common key into second encryption information with a public key and transmits the second encryption information to the shop terminal (300). The shop terminal (300) decrypts the second encryption information with a private key into the first encryption information and the common key, and decrypts the first encryption information with the decrypted common key into the commerce details information.

### BACKGROUND OF THE INVENTION

1. Field of the Invention

The present invention relates to an information processing device that transmits/receives information for performing commerce via a network, a system thereof, a method thereof, a program thereof and a recording medium recording the program.

2. Description of Related Art

Conventionally, commerce has widely been utilized for ordering of articles, booking of accommodations, or the like on The Internet. According to the commerce utilizing the The Internet, a user make an access to a web site constructed by an offerer of an article (subject of the commerce) from a terminal, who offers an article or an accommodation. Then, when the user inputs necessary information for the commerce with the terminal by following a window displayed on a display device of the terminal according to a web browser, namely by following a webpage, the commerce is performed. In performing the commerce, since the offerer of the article needs to specify the user, the offerer is required to obtain personal information such as a name and an address of the user as the necessary information. However, since an unspecified number of people can access to The Internet connections, the personal information must be transmitted to the offerer of the article properly without the leakage (for instance, see Document 1: JP-A-2001-312662, right column on page 5 to right column on page 8).

According to an arrangement disclosed in Document 1, when receiving an order request of an article from a user terminal, a shop server informs a customer management center about the reception of the order request. Then, when an orderer is new, the customer management center accepts the input of customer information, generates a user ID or the like and gives it to the customer, registers the generated user ID and the received customer information to a database, and informs the shop server that has accepted an order from the customer about the registration. On the other hand, when the orderer is the existing customer, the customer management center accepts inputting of the user ID, reads out the customer information corresponding to the user ID from the customer management database, and informs the shop server, which has accepted the order from the customer, about the result. Then the shop server performs processing related to selling of the article being ordered based on the customer information acquired from the customer management center.

Incidentally, as a method for preventing information from leaking to the outside, a cipher communication has been known (for instance, see Document 2: JP-A-11-168460, left column on page 7 to left column on page 19). With an arrangement disclosed in Document 2, a transmitter device encrypts a plain text with a common key and transmits the encrypted text as well as a key generating program of a public key encryption system to a receiver device connected to the transmitter device via a network. In the receiver device, a pair of the public key and a private key is generated according to the key generating program, and the public key is transmitted to the transmitter device whereas the private key is held in the receiver device. Then in the transmitter device, the common key is encrypted with the public key transmitted from the receiver device and the encrypted common key is transmitted to the receiver device. The receiver device decrypts the transmitted encrypted common key with the private key, and decrypts the decrypted text with the decrypted common key.

As described above, the necessary information such as the personal information at the time of the commerce with The Internet disclosed in Document 1 may be received or transmitted according to the arrangement of the cipher communication disclosed in Document 2. However, the user needs to acquire the public key and perform the encryption processing each time when the user performs the commerce, or even in the case of the existing user, the user needs to acquire the public key and perform the encryption processing after receiving the order request and informing the customer management center, thereby taking a time for the processing and causing a delay for the processing of the commerce.

### SUMMARY OF THE INVENTION

An object of the present invention is to provide an information processing device easily performing commerce, a system thereof, a method thereof, a program thereof and a recording medium recording the program.

An information processing device according to a first aspect of the present invention, which is managed by an article offerer, the information processing device performing commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, a commerce information generator for generating the commerce information according to an input operation of the article offerer; a storage controller for transmitting the commerce information to the connected server via the network and storing the commerce information in the server; a key generator for generating a pair of a public key and a private key; a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, generating second encryption information by encrypting the encrypted first encryption information and the common key with the public key, and transmitting the second encryption information via the network; and a decryption section for receiving and decrypting the second encryption information transmitted from the server into the first encryption information and the common key with the private key, and decrypting the first encryption information into the commerce details information with the decrypted common key.

An information processing device according to a second aspect of the present invention, which is managed by an article offerer, the information processing device performing commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, includes: a commerce information generator for generating the commerce information according to an input operation of the article offerer; a storage controller for transmitting the commerce information to the connected server via the network and storing the commerce information in the server; a key generator for generating a pair of a public key and a private key; a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, and generating second encryption information by encrypting the encrypted first encryption information and the common key with the public key; a confirmation signal receiver for receiving a confirmation signal indicating that the server has received the request signal; a reception controller for, when the confirmation signal receiver recognizes the reception of the confirmation signal, receiving the second encryption information from the server via the network; and a decryption section for decrypting the second encryption information received by the reception controller into the first encryption information and the common key with the private key, and decrypting the first encryption information into the commerce details information with the common key.

An information processing device according to a third aspect of the present invention, which is managed by an article offerer, the information processing device performing commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, includes: a commerce information generator for generating the commerce information according to an input operation of the article offerer; a storage controller for transmitting the commerce information to the connected server via the network and storing the commerce information in the server; a key generator for generating a pair of a public key and a private key; a common key reading section for reading out a common key from a storage section storing the common key being the same as a common key previously stored in the server; a transmittance controller for, when the storage controller transmits the commerce information to the server and stores the commerce information in the server, transmitting the public key to the server and storing the public key in the server, when the server recognizes the request signal, generating in the server first encryption information by encrypting the commerce details information received from the terminal with the common key, and generating second encryption information by encrypting the encrypted first encryption information with the public key; a confirmation signal receiver for receiving a confirmation signal indicating that the server has received the request signal; a reception controller for, when the confirmation signal receiver recognizes the reception of the confirmation signal, receiving the second encryption information from the server via the network; and a decryption section for decrypting the second encryption information received by the reception controller into the first encryption information with the private key, and decrypting the first encryption information into the commerce details information with the common key read out by the common key reading section.

An information processing system according to a fourth aspect of the present invention includes: a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and the above-described information processing device of the present invention connected to the server via the network in a manner capable of communicating.

An information processing system according to a fifth aspect of the present invention includes: a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and an information processing device connected to the server via the network in a manner capable of communicating for receiving the commerce details information from the server. The server includes: an information storage section for storing the commerce information; a common key storage section for storing a common key; a public key storage section for storing a public key transmitted from the information processing device; a receiver for receiving the request signal and the commerce details information from the terminal; an encryption section for generating first encryption information by encrypting the commerce details information with the common key stored in the common key storage section, and generating second encryption information by encrypting the generated first encryption information and the common key with the public key stored in the public key storage section; and a transmitter for transmitting the second encryption information to the information processing device. The information processing device includes: a commerce information generator for generating the commerce information; a key generator for generating a pair of a public key and a private key; a key transmitter for transmitting the public key with the commerce information to the server via the network; an information acquirer for receiving the second encryption information transmitted from the server; and a decryption section for decrypting the second encryption information acquired by the information acquirer into the first encryption information and the common key with the private key, and decrypting the first encryption information into the commerce details information with the decrypted common key.

An information processing system according to a sixth aspect of the present invention includes: server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and an information processing device connected to the server via the network in a manner capable of communicating for receiving the commerce details information from the server. The server includes: an information storage section for storing the commerce information; a common key storage section for storing a common key; a public key storage section for storing a public key transmitted from the information processing device; a receiver for receiving the request signal and the commerce details information from the terminal; an encryption section for generating first encryption information by encrypting the commerce details information with the common key stored in the common key storage section, and generating second encryption information by encrypting the generated first encryption information with the public key stored in the public key storage section; and a transmitter for transmitting the second encryption information to the information processing device. The information processing device includes: a commerce information generator for generating the commerce information; a key generator for generating a pair of a public key and a private key; a key storage section for storing a common key being the same as the common key in the server; a key transmitter for transmitting the public key with the commerce information to the server via the network; an information acquirer for receiving the second encryption information transmitted from the server; and a decryption section for decrypting the second encryption information acquired by the information acquirer into the first encryption information with the private key, and decrypting the first encryption information into the commerce details information with the common key stored in the key storage section.

An information processing method according to a seventh aspect of the present invention, which uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, includes the steps of: generating by the information processing device a pair of a public key and a private key and transmitting the public key to the server so as to be stored therein when the commerce information generated according to an input operation by the article offerer with the information processing device is transmitted to the server via the network and is stored in the server; when the server recognizes the request signal from the terminal corresponding to the commerce information, generating in the server first encryption information by encrypting the commerce details information received with the request signal with a common key, generating second encryption information by encrypting the encrypted first encryption information with the public key, and transmitting the second encryption information to the information processing device from the server via the network; and decrypting by the information processing device the second encryption information received from the server into the first encryption information with the private key, and decrypting the decrypted first encryption information into the commerce details information with a common key previously stored in the information processing device, the common key being the same as the common key in the server.

An information processing method according to an eighth aspect of the present invention, which uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, includes the steps of: generating by the information processing device a pair of a public key and a private key and transmitting the public key to the server so as to be stored therein when the commerce information generated according to an input operation by the article offerer with the information processing device is transmitted to the server via the network and is stored in the server; when the server recognizes the request signal from the terminal corresponding to the commerce information, transmitting a confirmation signal indicating that the request signal has received to the information processing device via the network, generating in the server first encryption information by encrypting the commerce details information received together with the request signal with a common key, and generating second encryption information by encrypting the encrypted first encryption information with the public key; and when the information processing device recognizes the confirmation signal, receiving the second encryption information from the server via the network, decrypting the received second encryption information into the first encryption information with the private key, and decrypting the decrypted first encryption information into the commerce details information with a common key previously stored in the information processing device and being the same as the common key in the server.

An information processing method according to a ninth aspect of the present invention, which uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, include the steps of: generating by the information processing device a pair of a public key and a private key and transmitting the public key to the server so as to be stored therein when the commerce information generated according to an input operation by the article offerer with the information processing device is transmitted to the server via the network and is stored in the server; when the server recognizes the request signal from the terminal corresponding to the commerce information, transmitting a confirmation signal related to that the request signal has received to the information processing device via the network, generating in the server first encryption information by encrypting the commerce details information received with the request signal with a common key, and generating second encryption information by encrypting the encrypted first encryption information and the common key with the public key; and when the information processing device recognizes the confirmation signal, receiving the second encryption information from the server via the network, decrypting the received second encryption information into the first encryption information and the common key with the private key, and decrypting the decrypted first encryption information into the commerce details information with the decrypted common key.

An information processing program according to a tenth aspect of the present invention operates the computing unit to function as the above-described information processing device of the present invention

An information processing program according to an eleventh aspect of the present invention operates the computing unit to execute the information processing method of the present invention.

A recording medium according to a twelfth aspect of the present invention records the information processing program in a manner readable by a computing unit.

### BRIEF DESCRIPTION OF THE DRAWINGS

FIG. 1 is a block diagram schematically showing an arrangement of an information processing system according to an embodiment of the present invention;

FIG. 2 is a block diagram schematically showing an arrangement of a server of the information processing system of aforesaid embodiment;

FIG. 3 is a conceptual diagram showing a top page window, which is a webpage of a web file displayed on a window display according to a web browser, of aforesaid embodiment;

FIG. 4 is a conceptual diagram showing an article details window, which is a webpage of the web file displayed by a window display according to the web browser, of aforesaid embodiment;

FIG. 5 is a conceptual diagram showing an order window, which is a webpage of the web file displayed by a window display according to the web browser, of aforesaid embodiment;

FIG. 6 is a block diagram schematically showing an arrangement of a shop terminal of the information processing system of aforesaid embodiment;

FIG. 7 is a flow chart showing an order processing operation of the information processing system of aforesaid embodiment; and

FIG. 8 is an explanatory illustration showing the order processing operation of the information processing system of aforesaid embodiment.

### DETAILED DESCRIPTION OF PREFERRED EMBODIMENT(S)

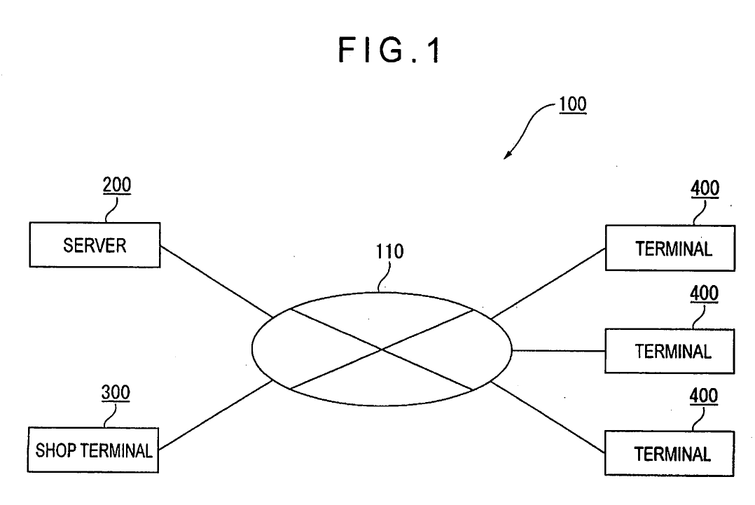

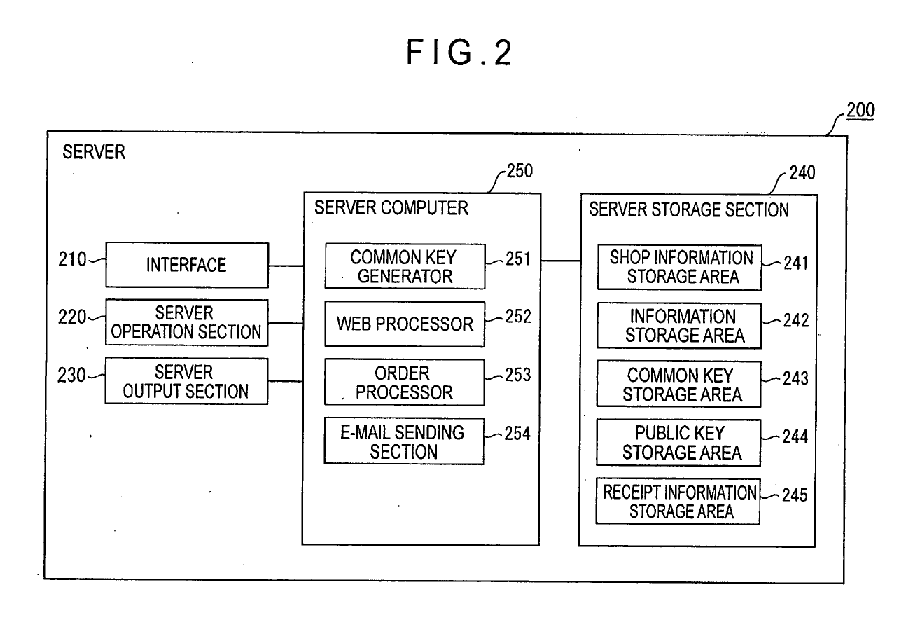

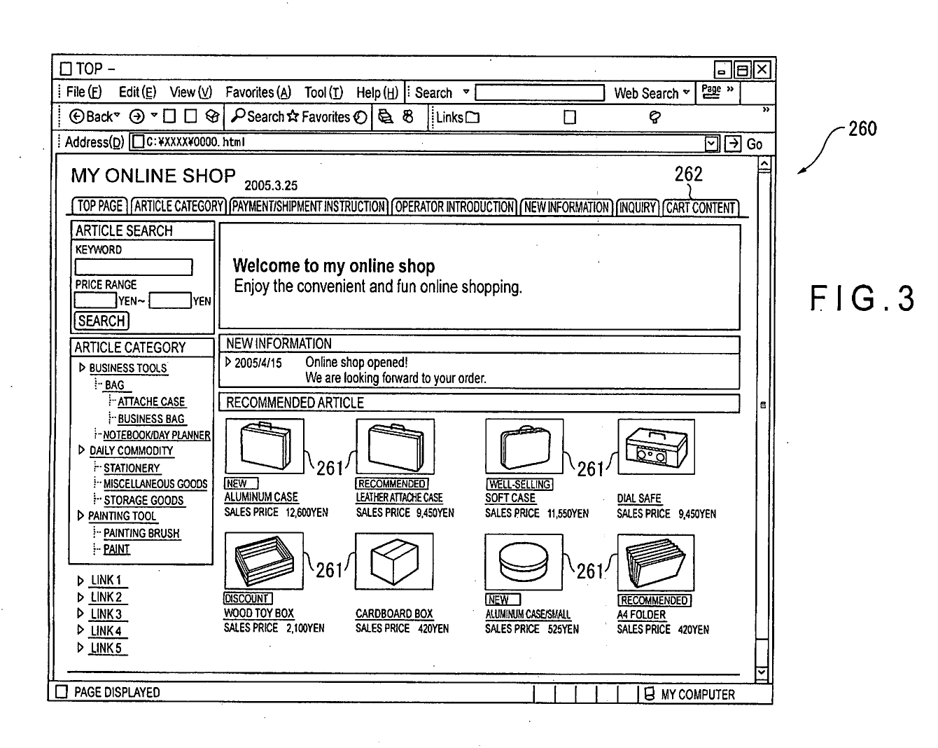

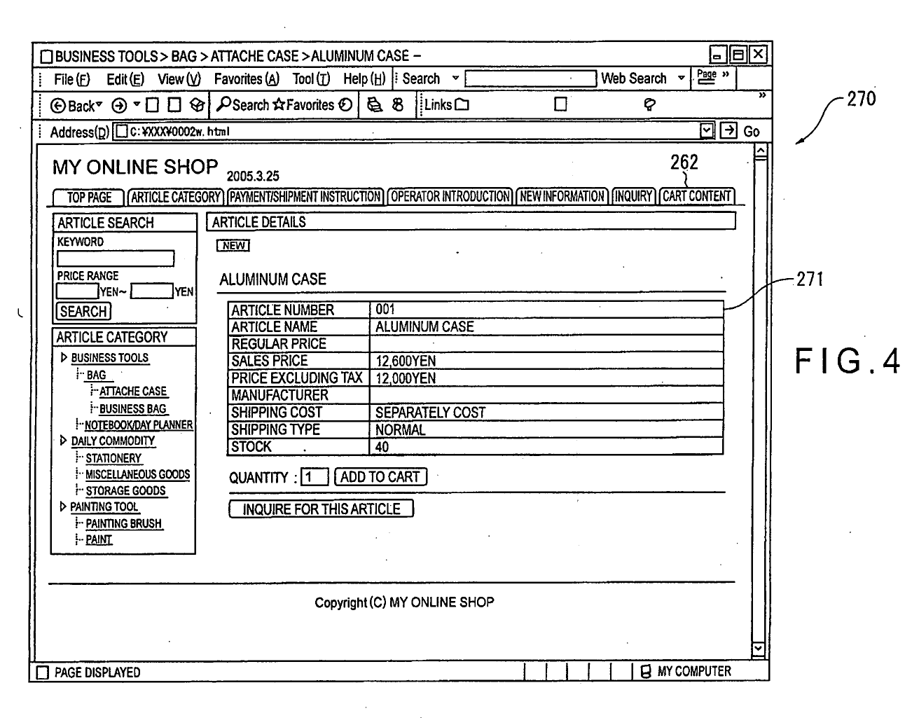

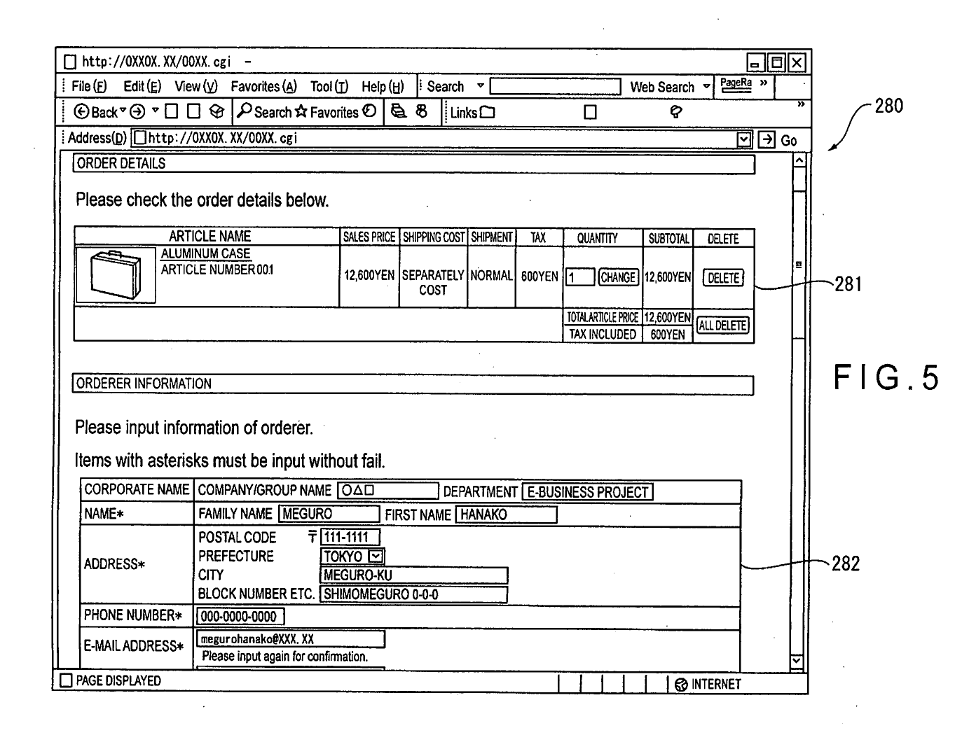

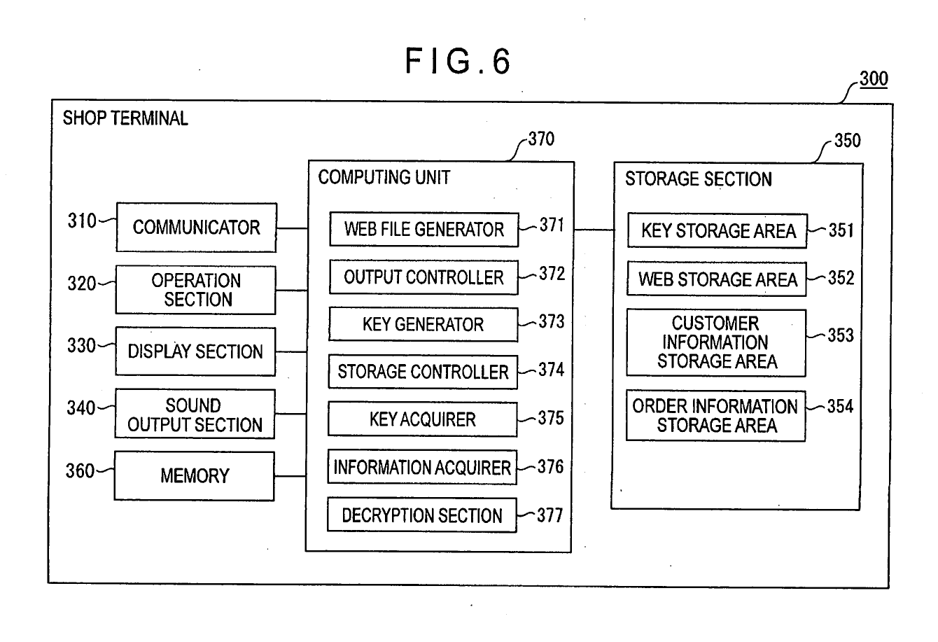

An embodiment of an information processing system provided with an information processing device of the present invention will be described below with attached drawings. FIG. 1 is a block diagram schematically showing an arrangement of the information processing system according to the embodiment of the present invention. FIG. 2 is a block diagram schematically showing an arrangement of a server of the information processing system. FIG. 3 is a conceptual diagram showing a top page window, which is a webpage of a web file displayed by a window display according to a web browser. FIG. 4 is a conceptual diagram showing an article details window, which is a webpage of the web file displayed by a window display according to the web browser. FIG. 5 is a conceptual diagram showing an order window, which is a webpage of the web file displayed by a window display according to the web browser. FIG. 6 is a block diagram schematically showing an arrangement of a shop terminal (information processing device) of the information processing system.

### Arrangement of Information Processing System

In FIG. 1, 100 denotes the information processing system, which is a system for performing commerce on a network 110, namely, for performing so-called online shopping such as ordering of articles (commerce items) or booking of accommodations (commerce items). Such commerce on the network 110 is, for instance, performed based on a web file (commerce information) described in the HTML (Hypertext Markup Language), which can be browsed as a webpage according to a web browser. In the present embodiment, a shop terminal 300 exemplary creates a web file using the HTML, however it is not limited thereto, and for instance, an arrangement for creating data described in other web language such as the XML (eXtensible Markup Language) or an interpreter language such as the Perl (Practical Extraction and Report Language), etc. can appropriately be used. The information processing system 100 includes a server 200 and the shop terminal 300 (information processing device), and is configured such that a terminal 400 managed by a customer (user requesting the commerce) can connect with the server 200.

The network 110 may be The Internet based on a general-purpose protocol such as TCP (Transmission Control Protocol)/IP (The Internet Protocol), an intranet, a LAN (Local Area Network), a communication network and a broadcasting network that have a plurality of base stations capable of communicating by way of a radio medium, or the radio medium itself that enables direct communication between the server 200 and the shop terminal 300 or the terminal 400. The radio medium may be any one of electric waves, light beams, acoustic waves and electromagnetic waves.

The server 200 is connected to the shop terminal 300 and the terminal 400 via the network 110 such that the server 200 can transmit/receive various information to/from the shop terminal 300 and the terminal 400. Note that the server 200 allows an unspecified number of the terminals 400 to access the server 200. Upon the access of the terminal 400 connected to the server 200 via the network 110, the server 200 allows a web file (commerce information, described later in detail) to be browsed as a webpage, and transmits various information related to commerce, the information being requested by the terminal 400 based on the webpage, to the shop terminal 300 via the network 110. The server 200 includes an interface 210, a server operation section 220, a server output section 230, a server storage section 240, a server computer 250, and the like.

The interface 210 is connected to the shop terminal 300 and the terminal 400 via the network 110, and also connected to the server computer 250. The interface 210 performs a preset input interface processing for a server signal input via the network 110 to output the server signal as a processing server signal to the server computer 250. When the processing server signal to be transmitted to the shop terminal 300 or the terminal 400 is input from the server computer 250 to the interface 210, the interface 210 performs a preset output interface processing for the input processing server signal to output the processing server signal as a server signal to the shop terminal 300 or the terminal 400 via the network 110.

The server operation section 220 is for instance a keyboard, a mouse, or the like, and has various operation buttons and operation knobs (each not shown) that can be used for input operation by a manager of the server 200. The operation buttons and the operation knobs are used for inputting settings such as: to input a setting for an entire operation of the server 200; to set information to be stored in the server storage section 240; and to update the information stored in the server storage section 240. When the settings are input, the server operation section 220 outputs a signal corresponding to the settings to the server computer 250 to apply the settings. In place of the operation buttons and the operation knobs, any type of input unit such as a touch panel arranged on the server output section 230 or a sound input section for the input operations can be employed as long as various settings can be set.

The server output section 230 is controlled by the server computer 250 connected thereto and displays a signal of image data output from the server computer 250. The server output section 230 may typically be a liquid-crystal panel, an organic EL (Electro Luminescence) panel, a PDP (Plasma Display Panel), a CRT (Cathode-Ray Tube), a FED (Field Emission Display), or an electrophoretic display panel.

The server storage section 240 is controlled by the server computer 250 connected thereto and stores various information readably by the server computer 250. The server storage section 240 may be any arrangement, e.g., a magnetic disk like a HD (Hard Disk), an optical disc like a DVD (Digital Versatile Disc), a drive or a driver that stores the various information in various type of recording medium like a memory card, a semiconductor memory, as long as information can be stored. The server storage section 240 includes a shop information storage area 241, an information storage area 242 (information storage section), a common key storage area 243 (common key storage section), a public key storage area 244 (public key storage section), a receipt information storage area 245, and the like.

The shop information storage area 241 has a table structure in which shop information related to a shop that is registered in the server 200 via the network 110 for allowing the connection to the server 200. The shop information includes identification information such as a registration number or a membership number that is an ID (identification) number; a name of a shop or a name of a representative of the shop managing the shop terminal 300; a living location, an address or a contact address; an e-mail address of the shop terminal 300 for transmitting/receiving various information via the network 110; a URL (Uniform Resource Locator); and the like, and those are associated in a single data structure.

The information storage area 242 stores a web file generated by the shop terminal 300. The web file is data constructed by various webpages that are described in the HTML (Hypertext Markup Language), which can be displayed as a webpage according to a web browser as shown in FIGS. 3 to 5 for instance. The information storage area 242 has a table structure in which specification information for specifying the shop is associated with each other as a single data structure, a plurality of the data structures being stored in the table structure. Herein, the specification information may be various information for specifying the shop and the shop terminal 300, for example, an identification number, an e-mail address or a URL of the shop terminal 300, each of which is included in the shop information.

Incidentally, FIG. 3 shows a top page window 260 that is a webpage of a web file. FIG. 4 shows an article details window 270 that is a webpage of the web file. FIG. 5 shows an order window 280 that is a webpage of the web file.

The top page window 260 shown in FIG. 3 is provided with article image areas 261 as plural pieces of article information, to which image data showing appearances of articles are attached. The article image area 261 has a linkage to the article details window 270 (article information) shown in FIG. 4 according to an input operation by clicking or the like. Further, provided on the top page window 260 shown in FIG. 3 is a tag icon allowing the order window 280 to be displayed according to the input operation by the click or the like.

In addition, provided on the article details window 270 shown in FIG. 4 is an article description form area 271 in which details and a dealing style etc. of the article are described. Further, provided on the order window 280 shown in FIG. 5 are: a pre-order form area 281 in which the subject article of the commerce, i.e., a pre-order status is described; a user specification form area 282 having a plurality of text boxes 282A that are guidance information for prompting a user, who makes an order, to set and input user information, i.e., settings related to the user; an order command button (not shown) for requesting performance of the commerce, that is, for allowing an order, and the like. Upon the input operation of the order command button, request information for requesting the performance of the commerce, an article number and a quantity for specifying the article that are details described in the pre-order form area 281, and commerce details information including the user information and the like described in the user specification form area 282 are generated. Namely, the server 200 receives the settings input according to the webpage, as the commerce details information from the terminal 400.

The common key storage area 243 stores a common key, which is information constructed by random numbers based on, for example, the specification information for cipher communication of information. At the time when the shop terminal 300 is registered in the server 200 in a manner connectable via the network 110 for using the information processing system 100 for instance, the common key is set by the server computer 250 in the server 200 for each shop terminal 300. Note that the common key may not be generated by the server 200, and may be generated by the shop terminal 300 and then stored in the server 200 after transmitting the common key from the shop terminal 300 via the network 110, or may be generated by the shop terminal 300 and then stored in the server 200 when the shop terminal 300 is registered in the server 200 in a manner connectable via the network 110 for using the information processing system 100. Incidentally, the common key storage area 243 is described as a table structure that stores a plurality of data structures, in each data structure, the common key being associated with the specification information for specifying the shop, however, only one key common to the shops may alternatively be stored.

The public key storage area 244 stores a public key, which is information for example constructed by random numbers for cipher communication of information. Though described later in detail, the public key is generated by the shop terminal 300 and transmitted from the shop terminal 300 via the network 110. The public key storage area 244 is constructed in a table structure that stores a plurality of data structures, in each data structure, the public key being associated with the specification information.

The receipt information storage area 245 is constructed in a table structure that stores plural pieces of commerce details information related to the details of the commerce input by the terminal 400 according to the web file each time the commerce is performed. To be more specific, the receipt information storage area 245 stores a plurality of the data structures, each data stricture includes the commerce details information related to the commerce; time information related to date and time when the setting of requesting the performance of the commerce is input, namely, when the server 200 recognizes the request information; specification information related to the subject web file; and IP information for specifying the terminal 400, which is a transmittance source. The commerce details information is constructed by associating customer information with a single data structure, in the customer information, the order details information described in the pre-order form area 281 in the order window 280 of the webpage of the web file, and the user information input in the text boxes 282A of the user specification form area 282 being associated with each other to be the single data structure.

The server storage section 240 also stores various programs that run on an OS (Operating System) controlling the whole operation of the server 200. Further, the server storage section 240 can temporarily store a signal to be processed by the server computer 250 in computation, in other words, can function as a memory.

The server computer 250 for instance includes a CPU (Central Processing Unit), and has various INPUT/OUTPUT ports (not shown) such as an INPUT/OUTPUT port connected to the interface 210, an input port connected to the server operation section 220, a display control port connected to the server output section 230, a storage port connected to the server storage section 240, and the like. The server computer 250 also includes as various programs a common key generator 251 also functioning as a key storage controller, a web processor 252 as an information storage controller, an order processor 253 as a receiver, an e-mail sending section 254 also functioning as an encryption section and a transmitter, and the like.

The common key generator 251 generates the public key which is the information generated by converting the identification number, the e-mail address, the URL or the like according to the random numbers. The common key generator 251 instructs the common key storage area 243 to store the generated common key such that the common key is associated with the specification information in a single data structure. Also, the common key generator 251 transmits the generated common key to the shop terminal 300. When transmitting the common key to the shop terminal 300, the common key generator 251 makes flag information, which is associated with the public key and stored, be changed from “0” indicating that the common key has not transmitted yet to “1” indicating that the common key has been transmitted, and stores the flag information. The common key generator 251 also makes the public key received from the shop terminal 300 via the network 110 be stored in the public key storage area 244.

A web processor 252 is constructed by a program that allows the server 200 to be functioned as a web server. The web processor 252 transmits a predetermined web file in a browsable manner in response to a web file browse request of client software etc. owned by the shop terminal 300 or the terminal 400, the web files being transmitted from the shop terminal 300 and stored in the information storage area 242 of the server storage section 240. The web processor 252 also executes a predetermined program such as a CGI (Common Gateway Interface) program, a SSI (Server Side Include) program, a Java (a programming language developed by Sun Microsystems, Inc.) program, or the like, in response to the request information of the shop terminal 300 or the terminal 400 to transmit the result thereof to the shop terminal 300 or a connected predetermined terminal 400.

The order processor 253 recognizes the commerce details information, which is the information of the settings related to the details of the commerce for performing the commerce transmitted from the terminal 400 in the shop, and makes the information be stored in the receipt information storage area 245 of the server storage section 240. The order processor 253 makes the customer information be stored in the receipt information storage area 245, the single customer information corresponding to the single commerce details information. In the customer information, the order details information described in the pre-order form area 281 and the user information input in the text boxes 282A of the user specification form area 282 in the order window 280 of the webpage of the web file being associated with each other to be the single data structure.

When recognizing a request of performing the commerce from the terminal 400, for instance, the request information for purchasing a predetermined article of the webpage, namely, when recognizing a signal corresponding to the input operation of the order command button, the e-mail sending section 254 transmits confirmation information indicating that the order request (performance request of commerce) to the shop terminal 300, for instance, by e-mail to inform that the order request has been recognized to the shop. The shop terminal 300, which is a destination of the confirmation information is recognized based on the specification information associated with the web file that is a subject of the commerce with the terminal 400 transmitting the request information. The e-mail sending section 254 transmits the confirmation information to the e-mail address of the shop terminal 300 in the recognized specification information.

Further, when recognizing from the shop terminal 300 transmittance request information for requesting of downloading the commerce details information, the e-mail sending section 254 transmits corresponding predetermined commerce details information to the requesting shop terminal 300 by e-mail. As the transmittance of the various information by e-mail, the e-mail sending section 254 generates first encryption information by encrypting the commerce details information with the common key associated with the specification information corresponding to the destination shop terminal 300, generates second encryption information by encrypting the generated first encryption information and the common key with a public key with the same specification information being associated, and transmits the generated second encryption information.

Note that the e-mail sending section 254 may encrypt not only the commerce details information, but also various information such as the confirmation information. Also, the e-mail sending section 254 may transmit a preset e-mail template such as “Thank you for shopping with us” or the like to the terminal 400 that has transmitted the request information.

The shop terminal 300 is a device that generates a web file and instructs the server 200 to store the web file in a manner browsable by the terminal 400 or the like, and acquires the commerce details information for performing the commerce in response to the order request from the terminal 400 via the server 200, so that the shop can perform that commerce based on the commerce details information. The shop terminal 300 may be any equipment, for instance, a mobile device like a personal computer or a mobile phone, a vehicle navigation device, a TV device, a video device, or the like as long as the equipment can make a communication via the network 110. As shown in FIG. 6, the shop terminal 300 includes a communicator 310, an operation section 320, a display section 330, a sound output section 340, a storage section 350, a memory 360, a computing unit 370, and the like.

The communicator 310 is connected to the network 110 in a manner capable of transmitting/receiving information. The communicator 310 is connected to the computing unit 370, so that, under the control of the computing unit 370, the communicator 310 can acquire a web file, video information, sound information from the server 200 connected via the network 110. The communicator 310 outputs the acquired various information to the computing unit 370.

The operation section 320 has various operation buttons and operation knobs (not shown) for an input operation in the same manner as the server operation section 220 of the server 200. The operation buttons and the operation knobs are used for inputting settings such as: to input a setting for an entire operation of the shop terminal 300; to input a setting for creating a web file; to set information to be stored in the shop terminal 300; and to update the information stored in the shop terminal 300. When the settings are input, the operation section 320 outputs a signal corresponding to the settings to the computing unit 370 to apply the settings. In place of the operation buttons and the operation knobs, any type of input unit such as a touch panel arranged on the display section 330 or a sound input section for the input operations can be employed as long as various settings can be set.

The display section 330 is controlled by the computing unit 370 connected thereto and displays a signal of image data output from the computing unit 370 in the same manner as the server operation section 220 of the server 200. The image data may be image data that is obtained by converting the web file acquired from the server 200 into an image, image data read out from the storage section 350 or the memory 360, TV image data received by a TV receiver (not shown), image data stored by an external device etc. in a recording medium such as an optical disc, a magnetic disc or a memory card and read out by way of a drive or a driver, or the like. The display section 330 may be various display device such as a liquid crystal panel, an organic EL panel, a PDP, a CRT, a FED, an electrophoretic display panel, or the like.

The sound output section 340 has a sound generator such as a speaker (not shown). The sound output section 340 is controlled by the computing unit 370 and outputs various sound data such as sound information or music information from the computing unit 370 as a sound by way of the sound generator. Note that the sound output section 340 may output TV sound data received by a TV receiver (not shown) and sound data stored in a recording medium, the storage section 350 or the memory 360.

The storage section 350 is controlled by the computing unit 370 connected thereto and stores various information readably by the computing unit 370. The storage section 350, like the server storage section 240 for instance, may be any arrangement such as a drive or a driver that readably stores information in various recording medium, a semiconductor memory, or the like as long as information can be stored therein. The storage section 350 includes a key storage area 351 (key storage section), a web storage area 352, a customer information storage area 353, an order information storage area 354, and the like.

The key storage area 351 is constructed in a table structure in which the public key and the private key, each of which is separately generated, are stored as a single data structure.

The web storage area 352 is constructed in a table structure in which the plural pieces of information such as a web file and image information and sound information attached (linked) to the web file are associated with each of the data structure. Also, associated with the web file is a predetermined area, namely, the URL in the information storage area 242 of the server 200 that is a destination of transferring the web file.

The customer information storage area 353 is constructed in a table structure in which the plural pieces of customer information are stored, each customer information being related to the customer who performed the commerce in the past or is currently performing the commerce. The customer information is constructed for instance such that the user information input in the text boxes 282A of the user specification form area 282 in the order window 280, which is the webpage of the web file, is associated with a single data structure. The customer information storage area 353 is constructed in a table structure in which customer number information such as an identification number assigned for each customer is associated with each of the customer information in a single data structure.

The order information storage area 354 is constructed in a table structure that stores the plural pieces of order details information defining the commerce details information input by the terminal 400 and transmitted from the server 200. In other words, the order details information of the commerce details information defines a single data structure associated with the customer number information for specifying the customer, and the time information related to date and time when the request information is transmitted from the server 200 and recognized by the server 200 with each other as order information. The order information storage area 354 is constructed in a table structure that stores a plurality of data structures, each of which makes the order information defined in the single data structure be associated with order number information such as an identification number that is assigned for each the order.

The memory 360 stores the settings to be input through the operation section 320, sound information, image information, and the like in a manner readable by the computing unit 370. The memory 360 also stores various programs that run on an OS (Operating System) controlling the whole operation of the shop terminal 300. The memory 360 may include a drive or a driver for readably storing data on a recording medium such as a HD, a DVD, or an optical disc.

The computing unit 370 has various INPUT/OUTPUT ports (not shown), such as a communication port connected to the communicator 310, a key input port connected to the operation section 320, a display port connected to the display section 330, a sound port connected to the sound output section 340, a storage port connected to the storage section 350, a memory port connected to the memory 360, and the like. The computing unit 370 has as various programs a web file generator 371 (commerce information generator), an output controller 372, a key generator 373, a storage controller 374 also functioning as a key transmitter and a transmittance controller, a key acquirer 375, an information acquirer 376 also functioning as a receipt controller, a decryption section 377, and the like.

The web file generator 371 creates a web file including webpages as shown in FIGS. 3 to 5 for instance described in the HTML, based on an operation signal corresponding to an input operation with the operation section 320 by a manager of a shop. When generating such a web file, various application software separately stored in the memory 360 or the like may be used. The created web file is appropriately output to and stored in the web storage area 352 of the storage section 350.

The output controller 372 appropriately controls the display section 330 and the sound output section 340 to output image data to the display section 330 for displaying it, and to output sound data to the sound output section 340 as a spimd.

The key generator 373 generates a pair of a public key and a private key. The generated public key and the private key are output to the key storage area 351 of the storage section 350 and stored therein.

The storage controller 374 transmits the web file to the server 200 connected thereto via the network 110, and instructs the web processor 252 in the server 200 to store the web file in the information storage area 242 of the server storage section 240. When transmitting the web file to the server 200 and storing the web file therein for first time, the storage controller 374 also transmits the public key previously generated by the key generator 373 and instructs the common key generator 251 in the server 200 to store the public key in the public key storage area 244 of the server storage section 240. By transmitting the public key, the storage controller 374 makes flag information, which is associated with the public key and stored in the key storage area 351 in the storage section 350, be changed from “0” indicating that the public key has not been transmitted yet to “1” indicating that the public key has been transmitted, and the stores the flag information. Further, when transmitting a web file newly created for updating the web file previously stored in the server 200, the storage controller 374 reads out the flag information of the public key stored in the key storage area 351. When the flag information indicates “0”, i.e., when the public key is newly generated and updated, the updated public key is transmitted together with the web file to be newly updated and then stored.

Though described later in detail, in order to decrypt with the decryption section 377 the information encrypted and transmitted from the server 200, the key acquirer 375 reads out the private key stored in the key storage area 351 and outputs the private key to the decryption section 377.

The information acquirer 376 receives various information such as second encryption information to be transmitted from the server 200 via the network 110. The received information is appropriately output to the storage section 350 or the memory 360 and stored therein.

The decryption section 377 decrypts the second encryption information received by the information acquirer 376. To be more specific, the decryption section 377 decrypts the received second encryption information with the private key that has been read out from the key storage area 351 by the key acquirer 375 into the first encryption information and the common key, and with the decrypted common key, the first encryption information is decrypted into the commerce details information. Then the decryption section 377 adequately outputs the decrypted commerce details information to the storage controller 374, so that the storage controller 374 instructs the storage section 350 to store the customer information of the commerce details information in the customer information storage area 353 and store the order information in the order information storage area 354.

The terminal 400 may be any equipment such as a personal computer, a mobile phone, a TV device, a video device, a navigation device or the like as long as the equipment can make a communication via the network 110. The terminal 400 includes, though not shown, a terminal communicator, a terminal operation section, a terminal display section, a terminal storage section, a terminal computer, and the like. The terminal communicator is connected to the server 200 via the network 110 in a manner capable of communication for transmitting/receiving various information so as to receive the web file and transmit settings input with the terminal operation section according to the web file. The terminal operation section can be input by a customer, or a user who performs the commerce to output a predetermined signal in accordance with the input operation, in the same manner as the server operation section 220 of the server 200 and as the operation section 320 of the shop terminal 300. The terminal display section is controlled by the terminal computer to display image data in the same manner as the server output section 230 and the display section 330. The terminal storage section stores the web file received from the server 200 and the settings input by the operation section etc. in a manner readable by the terminal computer. Also, the terminal storage section stores various programs such as a web browse client software, which is a program for processing the web file to be browsable. The terminal computer develops the various programs stored in the terminal storage section and performs computer-processing.

### Operation of Information Processing System

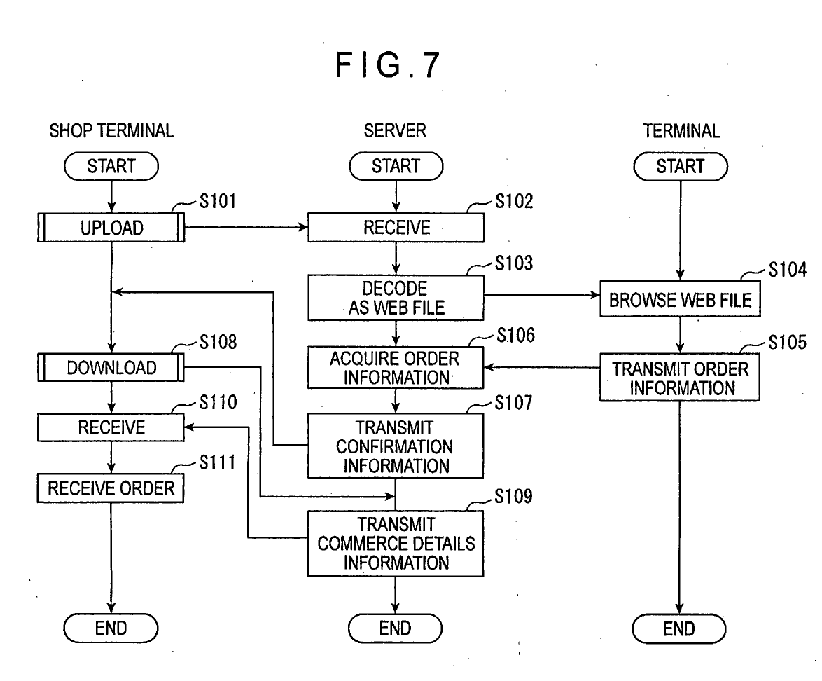

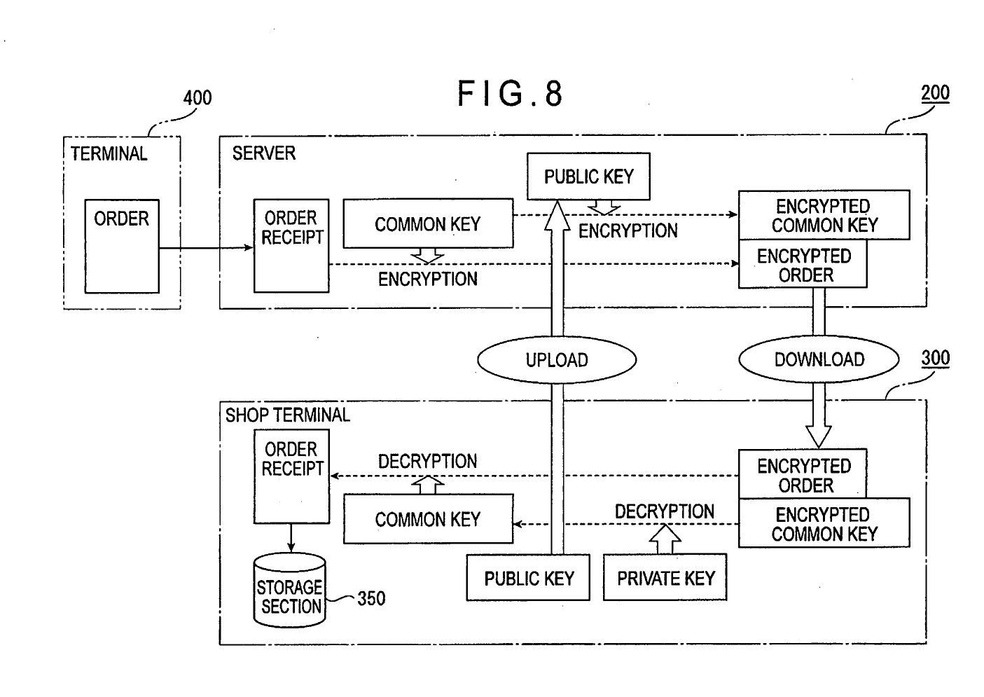

Next, as an operation of the above-described information processing system, an order processing operation of the information processing system 100 will be described below with reference to the drawings. FIG. 7 is a flow chart showing the order processing operation of the information processing system. FIG. 8 is a flow chart showing the order processing operation of the information processing system.

The shop terminal 300, under the control of the storage controller 374 of the computing unit 370, performs an upload processing to transmit the previously created web file with the public key previously generated by the key generator 373, shop information, initial directory information, etc. to the server 200 via the network 110 (Step S101). According to the upload processing in Step S101, the server 200 receives the web file with the public key (Step S102), makes the web file be stored in a predetermined storage area in the information storage area 242 of the server storage section 240 based on the initial directory information received by the web processor 252, and also instructs the common key generator 251 to store the public key in the public key storage area 244 of the server storage section 240. The web processor 252 then make the stored web file public on the network 110 to be browsable by the terminal 400 and the shop terminal 300 via the network 110 (Step S103). In this state, the server 200 becomes a reception standby state for the various information transmitted from the terminal 400 and the shop terminal 300 via the network 110.

In the state of Step S103, when recognizing the browse request information for requesting browse from the terminal 400 and the shop terminal 300, the server 200 transmits the web file in the server 200 to the terminal 400 and the shop terminal 300 in accordance with the browse request information. When acquiring the web file transmitted from the server 200, the terminal 400 instructs the terminal computer to develop the web browse client software to browse the acquired web file, i.e., to display the web file on the terminal display section as shown in FIGS. 3 to 5 for instance (Step S104).

In the terminal 400, when the user inputs the request for performing the commerce on a predetermined article according to the displayed web file, the input information, namely the commerce details information is transmitted to the server 200. To be more specific, by inputting the pre-order of the article to be requested for the commerce, like the order details information described in the pre-order form area 281 of the order window 280 shown in FIG. 5, which is a webpage of a web file; and by inputting the user information in a text form in the text boxes 282A of the user specification form area 282 and operating the order command button, not only the request information for requesting the performance of the commerce, but also the commerce details information in which the order details information and the customer information are associated with each other as a single data structure are transmitted to the server 200 via the network 110 (Step S105).

Then, when receiving the request information and the commerce details information transmitted from the terminal 400 in Step S105 (Step S106), the server 200 stores in the receipt information storage area 245 the commerce details information received by the order processor 253 of the server computer 250. Thereafter, the server 200 recognizes the specification information associated with the web file, which is subject of the commerce described in the request information received from the terminal 400, recognizes the shop terminal 300 based on the specification information, and instructs the e-mail sending section 254 to transmit the confirmation information on the order request, which is the performance request of the commerce, to the shop terminal 300 by e-mail according to an e-mail address described in the specification information of the recognized shop terminal 300 (Step S107).

In Step S107, when receiving the confirmation information to be transmitted from the server 200, the shop terminal 300 performs a download processing for the commerce details information corresponding to the order request (Step S108). In other words, the shop terminal 300 transmits not only the request information corresponding to the confirmation information transmitted from the server 200, but also transmittance request information to the server 200 for requesting transmittance of the commerce details information transmitted from the terminal 400. The server 200 with the transmittance request information received instructs the e-mail sending section 254 to transmit the commerce details information stored in the receipt information storage area 245 of the server 200 to the shop terminal 300 via the network 110 (Step S109). When transmitting the commerce details information in Step S109, the e-mail sending section 254 generates the first encryption information by encrypting the commerce details information read out from the receipt information storage area 245 with the common key associated with the specification information corresponding to the destination shop terminal 300, and generates the second encryption information by encrypting the generated first encryption information with the public key associated with the same specification information. Then the e-mail sending section 254 transmits the generated second encryption information to the shop terminal 300.

When in Step S109 the information acquirer 376 of the shop terminal 300 receives the second encryption information transmitted from the server 200 (Step S110), the shop terminal 300 instructs the decryption section 377 to decrypt the second encryption information with the private key read out from the key storage area 351 by the key acquirer 375 into the first encryption information and the common key, and to decrypt the first encryption information with the decrypted common key into the commerce details information. Then the decryption section 377 transmits the receipt confirmation information indicating that the decryption has successfully been completed to the server 200. The server 200 with the reception confirmation information received deletes from the receipt information storage area 245 the corresponding commerce details information being previously transmitted.

Then the decryption section 377 adequately outputs the decrypted commerce details information to the storage controller 374, so that the storage controller 374 instructs the storage section 350 to store the customer information of the commerce details information in the customer information storage area 353 and store the order information in the order information storage area 354. The shop terminal 300 instructs the output controller 372 to display the received and decrypted commerce details information on the display section 330 or the like to inform that the order request has been recognized to the manager or the like of the shop and to prompt the manager or the like to perform the order processing (commerce) (Step S111). Thus, the manager of the shop, who recognized the order request, would perform the commerce by dispatching the article, confirming payment, and the like.

### Advantages of Information Processing System

As described above, according to the above-described embodiment, the key generator 373 of the shop terminal 300 generates the pair of the public key and the private key in advance, transmits the previously created web file as well as the generated public key to the server 200 in accordance with the input operation by the manager of the shop or the like via the network 110, and stores the web file and the public key in the server 200. Then, with the terminal 400 managed by the user who performs online shopping by connecting to the server 200 via the network 110, according to the web file being stored in the server 200 and browsable on the network 110, the request information for requesting the performance of the commerce by the input operation of the user as well as the commerce details information are input and transmitted to the server 200. When recognizing the information, the server 200 transmits to the shop terminal 300 the confirmation information indicating that the order request has been made. Then, upon the recognition of the confirmation information, when the shop terminal 300 requests the download processing of the commerce details information to the server 200, the server 200 generates the first encryption information by encrypting the commerce details information with the common key, generates the second encryption information by encrypting the first encryption information and the common key with the public key, and transmits the second encryption information to the shop terminal 300. The shop terminal 300 that has received the second encryption information transmitted from the server 200 decrypts the second encryption information with the private key into the first encryption information and the common key, decrypts the first encryption information with the decrypted common key into the commerce details information, and acquires the commerce details information.

Accordingly, the commerce details at the time of online shopping and the customer information or the like of the user for performing the commerce can securely be prevented from leaking to the outside. Also, since the processing for transmitting the public key from the shop terminal 300 and storing the public key in the server 200 is performed at the time of the registration and the update of the web file for the server 200, a load on the communication can be decreased, the processing can be speeded up, and the commerce can easily be performed.

Further, since the server 200 transmits the commerce details information to the shop terminal 300 and receives the receipt confirmation, the order information including the transmitted commerce details information is deleted from the server 200. Accordingly, the server 200 can further securely be prevented from being accessed in an unauthorized manner causing leakage of the commerce details and the customer information.

Also, the server 200 stores the public key by associating with the specification information for specifying the shop terminal 300 and the manager of the shop, who manages the shop terminal 300, to be a single data structure. Accordingly, even when a plurality of the web files of the shops are registered in the server 200 and the server 200 is necessary to communicate with the plurality of shop terminals 300, the public key can properly and easily be read out for encryption processing with the simple table structure, thereby speeding up the processing, simplifying the arrangement of the server storage section 240, and facilitating the management thereof.

Further, the server 200 stores the web file information in the information storage area 242 by associating with the specification information, and encrypting the information with the corresponding public key in accordance with the specification information of the web file corresponding to the shop handling the article requested and ordered by the terminal 400. Accordingly, the leakage of the information can further be prevented by way of the simplified table structure.

Also, in a case where the public key is updated, the updated public key is transmitted to the server 200 at the time of updating the web file. Accordingly, the previous public key is used for the encryption and the decryption until the public key is updated in the server 200, whereas the new public key is used for the encryption and the decryption after the public key is updated. Since the public key is properly updated, the commerce details and the customer information can further securely be prevented from leaking.

Also, since the server computer 250 and the computing unit 370 are constructed as the programs by using the CPU or the like, installation of the programs allows the commerce to be performed on the network 110 as online shopping by making the programs function as the server 200 and the shop terminal 300, thereby easily expanding utilization. Further, since the programs are recorded in the recording medium and read out by a computer or the like, the server 200 and the shop terminal 300 for performing the online shopping can be constructed, so that the programs can easily be handled, thereby easily expanding the utilization. Note that the computing unit according to the present invention is not limited to one computer, and may be an arrangement in which a plurality of computers are combined in a network, an element such as the above-described CPU or a microcomputer, a circuit board on which a plurality of electric components are mounted, or the like.

### Modification of Embodiment

The present invention is not limited to the above specific embodiments, but includes modifications and improvements as long as the objects of the present invention can be attained.

To be more specific, the method, in which the server 200 transmits the confirmation information to the shop terminal 300 when recognizing the order request from the terminal 400, and as the shop terminal 300 requests the download processing according to the confirmation information, transmits the encrypted second encryption information to the shop terminal 300, is exemplified, however, the method is not limited thereto. For example, when receiving the commerce details information, the server 200 may transmit the commerce details information by encrypting it into the second encryption information directly to the corresponding shop terminal 300 without the confirmation information being transmitted.

The method, in which the server 200 generates the second encryption information with the public key by encrypting the common key and the first encryption information encrypted with the common key by the server 200, and the shop terminal 300 decrypts the second encryption information with the private key into the first encryption information and the common key, so that the first encryption information is decrypted with the decrypted common key, is exemplified, however, the method is not limited thereto. For instance, at the registration of the shop terminal 300 for connecting to the server 200, the common key may be preset in the server 200 and the shop terminal 300, the server 200 may generate the second encryption information with the public key from the first encryption information, which is encrypted with the common key, the shop terminal 300 may decrypt the second encryption information with the private key into the first encryption information, and the first encryption information may be decrypted with the previously stored common key, which is the same as the common key of the server 200.

The arrangements and the operating procedures for the present invention may be appropriately modified as long as the scope of the present invention can be attained.

### Effects of Embodiment

As described above, according to the above-described embodiment, the key generator 373 of the shop terminal 300 generates the pair of the public key and the private key in advance, transmits the previously created web file as well as the generated public key to the server 200 in accordance with the input operation by the manager of the shop or the like via the network 110, and stores the web file and the public key in the server 200. Then, with the terminal 400 managed by the user who performs online shopping by connecting to the server 200 via the network 110, according to the web file being stored in the server 200 and browsable on the network 10, the request information for requesting the performance of the commerce by the input operation of the user as well as the commerce details information are input and transmitted to the server 200. When recognizing the information, the server 200 transmits to the shop terminal 300 the confirmation information indicating that the order request has been made. Then, upon the recognition of the confirmation information, when the shop terminal 300 requests the download processing of the commerce details information to the server 200, the server 200 generates the first encryption information by encrypting the commerce details information with the common key, generates the second encryption information by encrypting the first encryption information and the common key with the public key, and transmits the second encryption information to the shop terminal 300. The shop terminal 300 that has received the second encryption information transmitted from the server 200 decrypts the second encryption information with the private key into the first encryption information and the common key, decrypts the first encryption information by the decrypted common key into the commerce details information, and acquires the commerce details information. Accordingly, the commerce details at the time of online shopping and the customer information or the like of the user for performing the commerce can securely be prevented from leaking to the outside. Also, since the processing for transmitting the public key from the shop terminal 300 and storing the public key in the server 200 is performed at the time of the registration and the update of the web file to the server 200, a load on the communication can be decreased, the processing can be speeded up, and the commerce can easily be performed.

As described above, according to the above-described embodiment, the key generator 373 of the shop terminal 300 generates the pair of the public key and the private key in advance, transmits the previously created web file as well as the generated public key to the server 200 in accordance with the input operation by the manager of the shop or the like via the network 110, and stores the web file and the public key in the server 200. Then, according to the terminal 400 managed by the user who performs online shopping by connecting to the server 200 via the network 110, according to the web file being stored in the server 200 and browsable on the network 110, the request information for requesting the performance of the commerce by the input operation of the user as well as the commerce details information are input and transmitted to the server 200. When recognizing the information, the server 200 generates the first encryption information by encrypting the commerce details information with the common key, generates the second encryption information by encrypting the generated first encryption information with the public key, and transmits the second encryption information to the shop terminal 300. The shop terminal 300 that has received the second encryption information transmitted from the server 200 decrypts the second encryption information with the private key into the first encryption information, decrypts the first encryption information with the previously stored common key, which is the same as the common key of the server 200, into the commerce details information, and acquires the commerce details information. Accordingly, the commerce details at the time of online shopping and the customer information or the like of the user for performing the commerce can securely be prevented from leaking to the outside. Also, since the processing for transmitting the public key from the shop terminal 300 and storing the public key in the server 200 is performed at the time of the registration and the update of the web file to the server 200, a load on the communication can be decreased, the processing can be speeded up, and the commerce can easily be performed.

As described above, according to the above-described embodiment, the key generator 373 of the shop terminal 300 generates the pair of the public key and the private key in advance, transmits the previously created web file as well as the generated public key to the server 200 in accordance with the input operation by the manager of the shop or the like via the network 110, and stores the web file and the public key in the server 200. Then, according to the terminal 400 managed by the user who performs online shopping by connecting to the server 200 via the network 110, according to the web file being stored in the server 200 and browsable on the network 110, the request information for requesting the performance of the commerce by the input operation of the user as well as the commerce details information are input and transmitted to the server 200. When recognizing the information, the server 200 transmits to the shop terminal 300 the confirmation information indicating that the order request has been made. Then, upon the recognition of the confirmation information, when the shop terminal 300 requests the download processing of the commerce details information to the server 200, the server 200 generates the first encryption information by encrypting the commerce details information with the common key, generates the second encryption information by encrypting the first encryption information and the common key with the public key, and transmits the second encryption information to the shop terminal 300. The shop terminal 300 that has received the second encryption information transmitted from the server 200 decrypts the second encryption information with the private key into the first encryption information, decrypts the first encryption information with the previously stored common key, which is the same as the common key of the server 200, into the commerce details information, and acquires the commerce details information. Accordingly, the commerce details at the time of online shopping and the customer information or the like of the user for performing the commerce can securely be prevented from leaking to the outside. Also, since the processing for transmitting the public key from the shop terminal 300 and storing the public key in the server 200 is performed at the time of the registration and the update of the web file to the server 200, a load on the communication can be decreased, the processing can be speeded up, and the commerce can easily be performed.

The priority application Number JP2005-114808 upon which this patent application is based is hereby incorporated by reference.

What is claimed is:

1. An information processing device managed by an article offerer, the information processing device performing commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, comprising:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, generating second encryption information by encrypting the encrypted first encryption information and the common key with the public key, and transmitting the second encryption information via the network; and
a decryption section for receiving and decrypting the second encryption information transmitted from the server into the first encryption information and the common key with the private key, and decrypting the first encryption information into the commerce details information with the decrypted common key.

2. The information processing device according to claim 1, wherein the transmittance controller, when the decryption section recognizes the reception of the second encryption information, deletes from the server the commerce details information transmitted from the server.

3. An information processing device managed by an article offerer, the information processing device performing commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, comprising:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, and generating second encryption information by encrypting the encrypted first encryption information and the common key with the public key;
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information and the common key with the private key, and decrypting the first encryption information into the commerce details information with the common key.

4. An information processing device managed by an article offerer, the information processing device performing commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, comprising:
a commerce information generator for generating the commerce information according to an input operation of the article offerer;
a storage controller for transmitting the commerce information to the connected server via the network and storing the commerce information in the server;
a key generator for generating a pair of a public key and a private key;
a common key reading section for reading out a common key from a storage section storing the common key being the same as a common key previously stored in the server;
a transmittance controller for, when the storage controller transmits the commerce information to the server and stores the commerce information in the server, transmitting the public key to the server and storing the public key in the server, when the server recognizes the request signal, generating in the server first encryption information by encrypting the commerce details information received from the terminal with the common key, and generating second encryption information by encrypting the encrypted first encryption information with the public key;
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information with the private key, and decrypting the first encryption information into the commerce details information with the common key read out by the common key reading section.

5. The information processing device according to claim 3, wherein the reception controller, when receiving the second encryption information, deletes from the server the commerce details information transmitted from the server.

6. The information processing device according to claim 4, wherein the reception controller, when receiving the second encryption information, deletes from the server the commerce details information transmitted from the server.

7. The information processing device according to claim 1, wherein the transmittance controller stores the public key in the server by associating the public key with specification information for specifying the article offerer in a data structure.

8. The information processing device according to claim 3, wherein the transmittance controller stores the public key in the server by associating the public key with specification information for specifying the article offerer in a data structure.

9. The information processing device according to claim 4, wherein the transmittance controller stores the public key in the server by associating the public key with specification information for specifying the article offerer in a data structure.

10. The information processing device according to claim 7, wherein
the storage controller stores the commerce information in the server by associating the commerce information with the specification information in a data structure, and
the transmittance controller, when the server recognizes the request signal, makes the specification information associated with the commerce information corresponding to the request signal be recognized, and generates the second encryption information by encrypting the first encryption information with the public key associated with the recognized specification information.

11. The information processing device according to claim 8, wherein
the storage controller stores the commerce information in the server by associating the commerce information with the specification information in a data structure, and
the transmittance controller, when the server recognizes the request signal, makes the specification information associated with the commerce information corresponding to the request signal be recognized, and generates the second encryption information by encrypting the first encryption information with the public key associated with the recognized specification information.

12. The information processing device according to claim 9, wherein
the storage controller stores the commerce information in the server by associating the commerce information with the specification information in a data structure, and
the transmittance controller, when the server recognizes the request signal, makes the specification information associated with the commerce information corresponding to the request signal be recognized, and generates the second encryption information by encrypting the first encryption information with the public key associated with the recognized specification information.

13. An information processing system, comprising:
a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and
an information processing device connected to the server via the network in a manner capable of communicating, wherein
the information processing device is managed by an article offerer, the information processing device performing the commerce according to the commerce details information that is received, via the server for storing the commerce information including the article information related to the article being subject of the commerce and guidance information to prompt inputting and setting related to the details of the commerce, from the terminal connected to the server via the network, the commerce details information being related to the details of the commerce and transmitted with the request signal input and set with the terminal according to the commerce information for requesting performance of the commerce includes:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, generating second encryption information by encrypting the encrypted first encryption information and the common key with the public key, and transmitting the second encryption information via the network; and
a decryption section for receiving decrypting the second encryption information transmitted from the server into the first encryption information and the common key with the private key, and decrypting the first encryption information into the commerce details information with the decrypted common key.

14. An information processing system, comprising:
a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and
an information processing device connected to the server via the network in a manner capable of communicating, wherein
the information processing device is managed by an article offerer, the information processing device performing the commerce according to the commerce details information that is received, via the server for storing the commerce information including the article information related to the article being subject of the commerce and guidance information to prompt inputting and setting related to the details of the commerce, from the terminal connected to the server via the network, the commerce details information being related to the details of the commerce and transmitted with the request signal input and set with the terminal according to the commerce information for requesting performance of the commerce includes:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, and generating second encryption information by encrypting the encrypted first encryption information and the common key with the public key;
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information and the common key with the private key, and decrypting the first encryption information into the commerce details information with the common key.

15. An information processing system, comprising:
a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and
an information processing device connected to the server via the network in a manner capable of communicating, wherein
the information processing device is managed by an article offerer, the information processing device performing the commerce according to the commerce details information that is received, via the server for storing the commerce information including the article information related to the article being subject of the commerce and guidance information to prompt inputting and setting related to the details of the commerce, from the terminal connected to the server via the network, the commerce details information being related to the details of the commerce and transmitted with the request signal input and set with the terminal according to the commerce information for requesting performance of the commerce includes:
a commerce information generator for generating the commerce information according to an input operation of the article offerer;
a storage controller for transmitting the commerce information to the connected server via the network and storing the commerce information in the server;
a key generator for generating a pair of a public key and a private key;
a common key reading section for reading out a common key from a storage section storing the common key being the same as a common key previously stored in the server;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with the common key, and generating second encryption information by encrypting the encrypted first encryption information with the public key;
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information with the private key, and decrypting the first encryption information into the commerce details information with the common key read out by the common key reading section.

16. An information processing system, comprising:
a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and
an information processing device connected to the server via the network in a manner capable of communicating for receiving the commerce details information from the server, wherein
the server includes:
an information storage section for storing the commerce information;
a common key storage section for storing a common key;
a public key storage section for storing a public key transmitted from the information processing device;
a receiver for receiving the request signal and the commerce details information from the terminal;
an encryption section for generating first encryption information by encrypting the commerce details information with the common key stored in the common key storage section, and generating second encryption information by encrypting the generated first encryption information and the common key with the public key stored in the public key storage section; and
a transmitter for transmitting the second encryption information to the information processing device,
the information processing device includes:
a commerce information generator for generating the commerce information;
a key generator for generating a pair of a public key and a private key;
a key transmitter for transmitting the public key with the commerce information to the server via the network;
an information acquirer for receiving the second encryption information transmitted from the server; and
a decryption section for decrypting the second encryption information acquired by the information acquirer into the first encryption information and the common key with the private key, and decrypting the first encryption information into the commerce details information with the decrypted common key.

17. An information processing system, comprising:
a server for storing commerce information including article information related to an article being subject of commerce and guidance information to prompt inputting and setting related to details of the commerce, and receiving commerce details information related to details of the commerce and transmitted with a request signal input and set with a terminal connected to the server via a network according to the commerce information for requesting performance of the commerce; and
an information processing device connected to the server via the network in a manner capable of communicating for receiving the commerce details information from the server, wherein
the server includes:
an information storage section for storing the commerce information;
a common key storage section for storing a common key;
a public key storage section for storing a public key transmitted from the information processing device;
a receiver for receiving the request signal and the commerce details information from the terminal;
an encryption section for generating first encryption information by encrypting the commerce details information with the common key stored in the common key storage section, and generating second encryption information by encrypting the generated first encryption information with the public key stored in the public key storage section; and
a transmitter for transmitting the second encryption information to the information processing device,
the information processing device includes:
a commerce information generator for generating the commerce information;
a key generator for generating a pair of a public key and a private key;
a key storage section for storing a common key being the same as the common key in the server;
a key transmitter for transmitting the public key with the commerce information to the server via the network;
an information acquirer for receiving the second encryption information transmitted from the server; and
a decryption section for decrypting the second encryption information acquired by the information acquirer into the first encryption information with the private key, and decrypting the first encryption information into the commerce details information with the common key stored in the key storage section.

18. The information processing system according to claim 16, wherein
the transmitter of the server, when recognizing the reception of the request signal with the receiver, transmits a confirmation signal indicating that the request signal has received to the information processing device, and
the information acquirer of the information processing device, when recognizing the confirmation signal transmitted from the transmitter, instructs the transmitter to transmit the second encryption information.

19. The information processing system according to claim 17, wherein
the transmitter of the server, when recognizing the reception of the request signal with the receiver, transmits a confirmation signal indicating that the request signal has received to the information processing device, and
the information acquirer of the information processing device, when recognizing the confirmation signal transmitted from the transmitter, instructs the transmitter to transmit the second encryption information.

20. The information processing system according to claim 16, wherein the transmitter of the server, when recognizing a reception signal indicating that the second encryption information has received from the information processing device, deletes the commerce details information corresponding to the transmitted second encryption information.

21. The information processing system according to claim 17, wherein the transmitter of the server, when recognizing a reception signal indicating that the second encryption information has received from the information processing device, deletes the commerce details information corresponding to the transmitted second encryption information.

22. The information processing system according to claim 16, wherein the server includes a key storage controller for storing in the public key storage section the public key transmitted from the information processing device by associating the public key with specification information for specifying the article offerer who manages the information processing device being a transmittance source in a data structure.

23. The information processing system according to claim 17, wherein the server includes a key storage controller for storing in the public key storage section the public key transmitted from the information processing device by associating the public key with specification information for specifying the article offerer who manages the information processing device being a transmittance source in a data structure.

24. The information processing system according to claim 22, wherein
the server includes an information storage controller for storing in the information storage section the commerce information transmitted from the information processing device by associating the commerce information with specification information for specifying the article offerer who manages the information processing device being a transmittance source in a data structure, and
the encryption section of the server, when the receiver receives the request signal, recognizes the specification information associated with the commerce information corresponding to the request signal and generates the second encryption information by encrypting the first encryption information with the public key associated with the recognized specification information and stored in the public key storage section.

25. The information processing system according to claim 23, wherein
the server includes an information storage controller for storing in the information storage section the commerce information transmitted from the information processing device by associating the commerce information with specification information for specifying the article offerer who manages the information processing device being a transmittance source in a data structure, and
the encryption section of the server, when the receiver receives the request signal, recognizes the specification information associated with the commerce information corresponding to the request signal and generates the second encryption information by encrypting the first encryption information with the public key associated with the recognized specification information and stored in the public key storage section.

26. An information processing method using a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the method using the computing unit comprising the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, generating in the server first encryption information by encrypting the commerce details information received with the request signal with a common key, generating second encryption information by encrypting the encrypted first encryption information with the public key, and transmitting the second encryption information to the information processing device from the server via the network; and
decrypting by the information processing device the second encryption information received from the server into the first encryption information with the private key, and decrypting the decrypted first encryption information into the commerce details information with a common key previously stored in the information processing device, the common key being the same as the common key in the server.

27. An information processing method using a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the method using the computing unit comprising the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, transmitting a confirmation signal indicating that the request signal has received to the information processing device via the network, generating in the server first encryption information by encrypting the commerce details information received together with the request signal with a common key, and generating second encryption information by encrypting the encrypted first encryption information with the public key; and
when the information processing device recognizes the confirmation signal, receiving the second encryption information from the server via the network, decrypting the received second encryption information into the first encryption information with the private key, and decrypting the decrypted first encryption information into the commerce details information with a common key previously stored in the information processing device and being the same as the common key in the server.

28. An information processing method using a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the method using the computing unit comprising the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, transmitting a confirmation signal related to that the request signal has received to the information processing device via the network, generating in the server first encryption information by encrypting the commerce details information received with the request signal with a common key, and generating second encryption information by encrypting the encrypted first encryption information and the common key with the public key; and
when the information processing device recognizes the confirmation signal, receiving the second encryption information from the server via the network, decrypting the received second encryption information into the first encryption information and the common key with the private key, and decrypting the decrypted first encryption information into the commerce details information with the decrypted common key.

29. An information processing program stored in a recording medium readably by a computing unit and operating the computing unit to function as an information processing device, wherein
the information processing device is managed by an article offerer and performs the commerce according to the commerce details information that is received, via the server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and the information processing device including:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, generating second encryption information by encrypting the encrypted first encryption information and the common key with the public key, and transmitting the second encryption information via the network; and
a decryption section for decrypting the second encryption information transmitted from the server into the first encryption information and the common key with the private key, and decrypting the first encryption information into the commerce details information with the decrypted common key.

30. An information processing program stored in a recording medium readably by a computing unit and operating the computing unit to function as an information processing device, wherein
the information processing device is managed by an article offerer and performs the commerce according to the commerce details information that is received, via the server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the information processing device including:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, and generating second encryption information by encrypting the encrypted first encryption information and the common key with the public key; and
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information and the common key with the private key, and decrypting the first encryption information into the commerce details information with the common key.

31. An information processing program stored in a recording medium readably by a computing unit and operating the computing unit to function as an information processing device, wherein
the information processing device is managed by an article offerer and performs the commerce according to the commerce details information that is received, via the server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the information processing device including:
a commerce information generator for generating the commerce information according to an input operation of the article offerer;
a storage controller for transmitting the commerce information to the connected server via the network and storing the commerce information in the server;
a key generator for generating a pair of a public key and a private key;
a common key reading section for reading out a common key from a storage section storing the common key being the same as a common key previously stored in the server;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with the common key, and generating second encryption information by encrypting the encrypted first encryption information with the public key;
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information with the private key, and decrypting the first encryption information into the commerce details information with the common key read out by the common key reading section.

32. An information processing program stored in a recording medium readably by a computing unit and operating the computing unit to execute an information processing method, wherein
the information processing method uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and
the method includes the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, generating first encryption information by encrypting the commerce details information received with the request signal with a common key, generating second encryption information by encrypting the encrypted first encryption information with the public key, and transmitting the second encryption information to the information processing device from the server via the network; and
decrypting by the information processing device the second encryption information received from the server into the first encryption information with the private key, and decrypting the decrypted first encryption information into the commerce details information with a common key previously stored in the information processing device, the common key being the same as the common key in the server.

33. An information processing program stored in a recording medium readably by a computing unit and operating the computing unit to execute an information processing method, wherein
the information processing method uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and
the method includes the steps of:
generating by the information processing device a pair of a public key and a private key and transmitting the public key to the server so as to be stored thereinwhen the commerce information generated according to an input operation by the article offerer with the information processing device is transmitted to the server via the network and is stored in the server;
when the server recognizes the request signal from the terminal corresponding to the commerce information, transmitting a confirmation signal indicating that the request signal has received to the information processing device via the network, generating in the server first encryption information by encrypting the commerce details information received together with the request signal with a common key, and generating second encryption information by encrypting the encrypted first encryption information with the public key; and
when the information processing device recognizes the confirmation signal, receiving the second encryption information from the server via the network, decrypting the received second encryption information into the first encryption information with the private key, and decrypting the decrypted first encryption information into the commerce details information with the common key previously stored in the information processing device and being the same as the common key in the server.

34. An information processing program stored in a recording medium readably by a computing unit and operating the computing unit to execute an information processing method, wherein
the information processing method uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and
the method includes the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, transmitting a confirmation signal related to that the request signal has received to the information processing device via the network, generating in the server first encryption information by encrypting, the commerce details information received with the request signal with a common key, and generating second encryption information by encrypting the encrypted first encryption information and the common key with the public key; and
when the information processing device recognizes the confirmation signal, receiving the second encryption information from the server via the network, decrypting the received second encryption information into die first encryption information and the common key with the private key, and decrypting the decrypted first encryption information into the commerce details information with the decrypted common key.

35. A recording medium recording an information processing program in a manner readable by a computing unit, wherein
the information processing program operates the computing unit as an information processing device,
the information processing device is managed by an article offerer and performs the commerce according to the commerce details information that is received, via the server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the information processing device including:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, generating second encryption information by encrypting the encrypted first encryption information and the common key with the public key, and transmitting the second encryption information via the network; and
a decryption section for receiving and decrypting the second encryption information transmitted from the server into the first encryption information and the common key with the private key, and decrypting the first encryption information into the commerce details information with the decrypted common key.

36. A recording medium recording an information processing program in a manner readable by a computing unit, wherein
the information processing program operates the computing unit as an information processing device,
the information processing device is an information processing device managed by an article offerer and performs commerce according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the information processing device including:
a commerce information generator for generating the commerce information according to an input operation of the article offerer;
a storage controller for transmitting the commerce information to the connected server via the network and storing the commerce information in the server;
a key generator for generating a pair of a public key and a private key;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with a common key previously stored in the server, and generating second encryption information by encrypting the encrypted first encryption information and the common key with the public key; and
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information and the common key with the private key, and decrypting the first encryption information into the commerce details information with the common key.

37. A recording medium recording an information processing program in a manner readable by a computing unit, wherein
the information processing program operates the computing unit as an information processing device,
the information processing device is managed by an article offerer and performing the commerce according to the commerce details information that is received, via the server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, the information processing device including:
a commerce information generator for generating the commerce information according to an input operation of the article offerer;
a storage controller for transmitting the commerce information to the connected server via the network and storing the commerce information in the server;
a key generator for generating a pair of a public key and a private key;
a common key reading section for reading out a common key from a storage section storing the common key being the same as a common key previously stored in the server;
a transmittance controller for, when the storage controller transmits the commerce information to the server and stores the commerce information in the server, transmitting the public key to the server and storing the public key in the server, when the server recognizes the request signal, generating first encryption information by encrypting the commerce details information received from the terminal with the common key, and generating second encryption information by encrypting the encrypted first encryption information with the public key;
a confirmation signal receiver for receiving a confirmation signal indicating that the server has received the request signal;
a reception controller for, when the confirmation signal receiver recognizes the reception of the confirmation signal, receiving the second encryption information from the server via the network; and
a decryption section for decrypting the second encryption information received by the reception controller into the first encryption information with the private key, and decrypting the first encryption information into the commerce details information with the common key read out by the common key reading section.

38. A recording medium recording an information processing program in a manner readable by a computing unit, wherein
the information processing program operates the computing unit to execute an information processing method,
the information processing method uses a computing unit for receiving commerce details information with an information processing device managed by an article offerer according to commerce details information that is received, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and
the method includes the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, generating first encryption information by encrypting the commerce details information received with the request signal with a common key, generating second encryption information by encrypting the encrypted first encryption information with the public key, and transmitting the second encryption information to the information processing device from the server via the network; and
decrypting by the information processing device the second encryption information received from the server into the first encryption information with the private key, and decrypting the decrypted first encryption information into the commerce details information with a common key previously stored in the information processing device, the common key being the same as the common key in the server.

39. A recording medium recording an information processing program in a manner readable by a computing unit, wherein
the information processing program operates the computing unit to execute an information processing method,
the information processing method uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and
the method includes the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, transmitting a confirmation signal indicating that the request signal has received to the information processing device via the network, generating in the server first encryption information by encrypting the commerce details information received together with the request signal with a common key, and generating second encryption information by encrypting the encrypted first encryption information with the public key; and
when the information processing device recognizes the confirmation signal, receiving the second encryption information from the server via the network, decrypting the received second encryption information into the first encryption information with the private key, and decrypting the decrypted first encryption information into the commerce details information with the common key previously stored in the information processing device and being the same as the common key in the server.

40. A recording medium recording an information processing program in a manner readable by a computing unit, wherein
the information processing program operates the computing unit to execute an information processing method,
the information processing method uses a computing unit for receiving commerce details information with an information processing device managed by an article offerer according to the commerce details information, via a server for storing commerce information including article information related to an article being subject of the commerce and guidance information to prompt inputting and setting related to details of the commerce, from a terminal connected to the server via a network, the commerce details information being related to the details of the commerce and transmitted with a request signal input and set with the terminal according to the commerce information for requesting performance of the commerce, and
the method includes the steps of:
generating by the information processing device a pair of a public key and a private key and transmitting the public key to the server so as to be stored therein when the commerce information generated according to an input operation by the article offerer with the information processing device is transmitted to the server via the network and is stored in the server;
when the server recognizes the request signal from the terminal corresponding to the commerce information, transmitting a confirmation signal related to that the request signal has received to the information processing device via the network, generating in the server first encryption information by encrypting the commerce details information received with the request signal with a common key, and generating second encryption information by encrypting the encrypted first encryption information and the common key with the public key; and
when the information processing device recognizes the confirmation signal, receiving the second encryption information from the server via the network, decrypting the received second encryption information into the first encryption information and the common key with the private key, and decrypting the decrypted first encryption information into the commerce details information with the decrypted common key.
